(19) United States
(12) Patent Application Publication
(10) Pub. No.: US 2005/0260324 A1
(43) Pub. Date: Nov. 24, 2005

(54) Aromatized wine-based drink

(75) Inventor: Massimo Bortolato, Pescantina (IT)

Correspondence Address: BROWDY AND NEIMARK, P.L.L.C.;624 NINTH STREET, NW, SUITE 300, WASHINGTON, DC, 20001-5303, US

(73) Assignee: Enoitalia S.p.A., Calmasino Di Bardolino (IT)

(21) Appl. No.: 11/101,454

(22) Filed: Apr. 8, 2005

(30) Foreign Application Priority Data
May 18, 2004 (IT) IT-VR2004A000083

(51) Int. Cl. C12G 1/00

(52) U.S. Cl. 426/592

(57) ABSTRACT

An aromatized wine-based drink comprises a first wine selected from amongst Pinot grigio, Merlot, Shiraz and Prosecco with a percentage by weight of between 51% and 99.4%, rectified concentrated grape must with a percentage by weight of between 0.5% and 5% and a mixture of natural vanilla flavoring and vanilla extract with a percentage by weight of not less than 0.1%. The drink may also comprise a second wine with a percentage by weight not higher than 48.4%.

### BACKGROUND OF THE INVENTION

The present invention relates to an aromatized wine-based drink.

The term aromatized wind-based drink derives from the European standard currently in force relative to the wine-making sector.

Therefore, reference is made herein to aromatized wine-based drinks meaning, in accordance with what is established by the above-mentioned standard, a drink to which a flavoring, sweetener or water have been added, and obtained from one or more of the following wine products:
new wine still fermenting; wine intended to become table wine; table wine; sparkling wine; aerated sparkling wine; semi-sparkling wine; aerated semi-sparkling wine; grape must and/or partially fermented grape musts.

Such drinks have an effective alcoholic strength by volume of between 7% and 15% by volume. Moreover, in the finished product the wines must represent at least 50% of the weight.

At present aromatized drinks on the market are aromatized with flavorings intended to give the basic wine organoleptic attributes different to those of the wine.

In particular, fruit flavorings are normally used.

### SUMMARY OF THE INVENTION

The technical need which forms the basis of the present invention is to provide an aromatized wine-based drink in which flavoring enhances only the organoleptic attributes of the wine itself.

In particular, the technical need of the present invention is to provide an aromatized wine-based drink in which the organoleptic attributes of the basic wine are enhanced in a way similar to that which could be achieved by aging the basic wine in casks.

The technical need specified and the aims indicated are substantially achieved by an aromatized wine-based drink as described in the claims herein.

### DESCRIPTION OF THE PREFERRED EMBODIMENTS

Other features and advantages of the invention are more clearly indicated in the detailed description which follows with reference to several preferred non-restricting embodiments of an aromatized wine-based drink.

The aromatized wine-based drink disclosed comprises firstly a basic component which will be referred to herein as the “first wine”, which is either a wine obtained from a single variety of vine or a generic wine without indication of vine. In particular, in the preferred embodiment, it is a first wine selected from Pinot grigio, Merlot, Shiraz, and Prosecco.

Generally speaking, said first wine may therefore be either a white wine or a red wine.

In the case of Prosecco wine, it may be either semi-sparkling Prosecco or sparkling Prosecco.

A characteristic shared by the four above-mentioned wines is the fact that their organoleptic features include a hint of vanilla.

The presence of the first wine varies from case to case according to requirements. In general, it is present with a percentage by weight of between 51% and 99.4% of the total aromatized drink.

Advantageously, the first wine has a starting alcohol content of between 10% and 12% by volume, preferably approximately 11% by volume.

The second basic component of the drink disclosed is rectified concentrated grape must which is put into the drink with a percentage by weight of between 0.5% and 5%.

The rectified concentrated grape must preferably has a sugar content of between 60 and 75 Brix, advantageously between 67 and 69 Brix.

Another basic component of the aromatized wine-based drink disclosed is a mixture of natural vanilla flavoring and vanilla extract, present in the drink with a percentage by weight of not less than 0.1%.

Said mixture is obtained in an alcoholic solvent of ethyl alcohol at 49% by volume.

Advantageously, the mixture used is a mixture of natural flavoring preparations including natural oak flavoring, in particular of the botanical species Quercus robur or pedunculate oak, Quercus petraea and Quercus sessilis, and natural vanilla pod “vanilla planifolia” extract.

The natural oak flavoring enhances the vanilla flavoring.

An example of the mixture is represented by the product identified with number ER: 4258 Vanilla Flavour, produced and marketed by Fructamine S.p.A., a company with registered office in Italy.

The percentage of the flavoring mixture used varies from case to case according to the desired effect and the composition of the mixture itself.

Every mixture has a different capacity for flavoring the drink.

As a result, the same results may be achieved, the proportions of other ingredients being equal, either with limited quantities of a mixture with strong flavoring capacity, or with larger quantities of mixtures with weaker flavoring capacity.

According to the embodiments, the aromatized drink may also comprise, or not comprise, a “second wine” with a percentage by weight not above 48.4%.

This second wine may by any wine, although it will preferably have a starting alcohol content of between 10% and 12% by volume, in particular equal to approximately 11% by volume. Advantageously, the alcohol content substantially corresponds to that of the first wine.

Advantageously, when the first wine is a white wine, such as Pinot grigio or Prosecco, the second wine is a white wine, whilst when the first wine is a red wine, such as Merlot or Shiraz, the second wine is also a red wine.

The following are some examples of aromatized wine-based drinks made in accordance with the present invention.

Examples of drinks with Pinot grigio as the first wine.

### EXAMPLE 1

51.90% white Pinot grigio wine with a starting alcohol content of ±11% by volume;
47.00% white wine with a starting alcohol content of ±11% by volume;
1.00% rectified concentrated grape must with a sugar content of ±67.8 Brix;
0.10% vanilla extract and natural flavoring in an alcoholic solvent of ethyl alcohol at 49% by volume.

### EXAMPLE 2

51.90% white Pinot grigio wine with a starting alcohol content of ±11% by volume;
44.60% white wine with a starting alcohol content of ±11% by volume;
3.00% rectified concentrated grape must with a sugar content of ±67.8 Brix;
0.50% vanilla extract and natural flavoring in an alcoholic solvent of ethyl alcohol at 49% by volume.

### EXAMPLE 3

51.90% white Pinot grigio wine with a starting alcohol content of ±11% by volume;
44.10% white wine with a starting alcohol content of ±11% by volume;
3.00% rectified concentrated grape must with a sugar content of ±67.8 Brix;
1.00% vanilla extract and natural flavoring in an alcoholic solvent of ethyl alcohol at 49% by volume.

### EXAMPLE 4

98.9% white Pinot grigio wine with a starting alcohol content of ±11% by volume;
1.00% rectified concentrated grape must with a sugar content of ±67.8 Brix;
0.1% vanilla extract and natural flavoring in an alcoholic solvent of ethyl alcohol at 49% by volume.

### EXAMPLE 5

96.5% white Pinot grigio wine with a starting alcohol content of ±11% by volume;
3.00% rectified concentrated grape must with a sugar content of ±67.8 Brix;
0.5% vanilla extract and natural flavoring in an alcoholic solvent of ethyl alcohol at 49% by volume.

### EXAMPLE 6

96.0% white Pinot grigio wine with a starting alcohol content of ±11% by volume;
3.00% rectified concentrated grape must with a sugar content of ±67.8 Brix;
1.00% vanilla extract and natural flavoring in an alcoholic solvent of ethyl alcohol at 49% by volume.

Examples of drinks with Merlot as the first wine.

### EXAMPLE 7

51.90% red Merlot wine with a starting alcohol content of ±11% by volume;
47.00% red wine with a starting alcohol content of ±11% by volume;
1.00% rectified concentrated grape must with a sugar content of ±67.8 Brix;
0.10% vanilla extract and natural flavoring in an alcoholic solvent of ethyl alcohol at 49% by volume.

### EXAMPLE 8

51.90% red Merlot wine with a starting alcohol content of ±11% by volume;
44.60% red wine with a starting alcohol content of ±11% by volume;
3.00% rectified concentrated grape must with a sugar content of ±67.8 Brix;
0.50% vanilla extract and natural flavoring in an alcoholic solvent of ethyl alcohol at 49% by volume.

### EXAMPLE 9

51.90% red Merlot wine with a starting alcohol content of ±11% by volume;
44.10% red wine with a starting alcohol content of ±11% by volume;
3.00% rectified concentrated grape must with a sugar content of ±67.8 Brix;
1.00% vanilla extract and natural flavoring in an alcoholic solvent of ethyl alcohol at 49% by volume.

### EXAMPLE 10

98.9% red Merlot wine with a starting alcohol content of ±11% by volume;
1.00% rectified concentrated grape must with a sugar content of ±67.8 Brix;
0.1% vanilla extract and natural flavoring in an alcoholic solvent of ethyl alcohol at 49% by volume.

### EXAMPLE 11

96.5% red Merlot wine with a starting alcohol content of ±11% by volume;
3.00% rectified concentrated grape must with a sugar content of ±67.8 Brix;
0.5% vanilla extract and natural flavoring in an alcoholic solvent of ethyl alcohol at 49% by volume.

### EXAMPLE 12

96.0% red Merlot wine with a starting alcohol content of ±11% by volume;
3.00% rectified concentrated grape must with a sugar content of ±67.8 Brix;
1.00% vanilla extract and natural flavoring in an alcoholic solvent of ethyl alcohol at 49% by volume.

Examples of drinks with Shiraz as the first wine.

### EXAMPLE 13

51.90% red Shiraz wine with a starting alcohol content of ±11% by volume;
47.00% red wine with a starting alcohol content of ±11% by volume;
1.00% rectified concentrated grape must with a sugar content of ±67.8 Brix;
0.10% vanilla extract and natural flavoring in an alcoholic solvent of ethyl alcohol at 49% by volume.

### EXAMPLE 14

51.90% red Shiraz wine with a starting alcohol content of ±11% by volume;
44.60% red wine with a starting alcohol content of ±11% by volume;
3.00% rectified concentrated grape must with a sugar content of ±67.8 Brix;
0.50% vanilla extract and natural flavoring in an alcoholic solvent of ethyl alcohol at 49% by volume.

### EXAMPLE 15

51.90% red Shiraz wine with a starting alcohol content of ±11% by volume;
44.10% red wine with a starting alcohol content of ±11% by volume;
3.00% rectified concentrated grape must with a sugar content of ±67.8 Brix;
1.00% vanilla extract and natural flavoring in an alcoholic solvent of ethyl alcohol at 49% by volume.

### EXAMPLE 16

98.9% red Shiraz wine with a starting alcohol content of ±11% by volume;
1.00% rectified concentrated grape must with a sugar content of ±67.8 Brix;
0.1% vanilla extract and natural flavoring in an alcoholic solvent of ethyl alcohol at 49% by volume.

### EXAMPLE 17

96.5% red Shiraz wine with a starting alcohol content of ±11% by volume;
3.00% rectified concentrated grape must with a sugar content of ±67.8 Brix;
0.5% vanilla extract and natural flavoring in an alcoholic solvent of ethyl alcohol at 49% by volume.

### EXAMPLE 18

96.0% red Shiraz wine with a starting alcohol content of ±11% by volume;
3.00% rectified concentrated grape must with a sugar content of ±67.8 Brix;
1.00% vanilla extract and natural flavoring in an alcoholic solvent of ethyl alcohol at 49% by volume.

Examples of drinks with semi-sparkling Prosecco wine as the first wine.

### EXAMPLE 19

51.90% white semi-sparkling Prosecco wine with a starting alcohol content of ±11% by volume;
47.00% white semi-sparkling wine with a starting alcohol content of ±11% by volume;
1.00% rectified concentrated grape must with a sugar content of ±67.8 Brix;
0.10% vanilla extract and natural flavoring in an alcoholic solvent of ethyl alcohol at 49% by volume;
5 g/l carbon dioxide deriving from natural fermentation.

### EXAMPLE 20

51.90% white semi-sparkling Prosecco wine with a starting alcohol content of ±11% by volume;
44.60% white semi-sparkling wine with a starting alcohol content of ±11% by volume;
3.00% rectified concentrated grape must with a sugar content of ±67.8 Brix;
0.50% vanilla extract and natural flavoring in an alcoholic solvent of ethyl alcohol at 49% by volume;
5 g/l carbon dioxide deriving from natural fermentation.

### EXAMPLE 21

51.90% white semi-sparkling Prosecco wine with a starting alcohol content of ±11% by volume;
44.10% white semi-sparkling wine with a starting alcohol content of ±11% by volume;
3.00% rectified concentrated grape must with a sugar content of ±67.8 Brix;
1.00% vanilla extract and natural flavoring in an alcoholic solvent of ethyl alcohol at 49% by volume;
5 g/l carbon dioxide deriving from natural fermentation.

### EXAMPLE 22

98.9% white semi-sparkling Prosecco wine with a starting alcohol content of ±11% by volume;
1.00% rectified concentrated grape must with a sugar content of ±67.8 Brix;
0.1% vanilla extract and natural flavoring in an alcoholic solvent of ethyl alcohol at 49% by volume;
5 g/l carbon dioxide deriving from natural fermentation.

### EXAMPLE 23

96.5% white semi-sparkling Prosecco wine with a starting alcohol content of ±11% by volume;
3.00% rectified concentrated grape must with a sugar content of ±67.8 Brix;
0.5% vanilla extract and natural flavoring in an alcoholic solvent of ethyl alcohol at 49% by volume;
5 g/l carbon dioxide deriving from natural fermentation.

### EXAMPLE 24

96.0% white semi-sparkling Prosecco wine with a starting alcohol content of ±11% by volume;
3.00% rectified concentrated grape must with a sugar content of ±67.8 Brix;
1.00% vanilla extract and natural flavoring in an alcoholic solvent of ethyl alcohol at 49% by volume;
5 g/l carbon dioxide deriving from natural fermentation.

Examples of drinks with sparkling Prosecco wine as the first wine.

### EXAMPLE 25

51.90% white sparkling Prosecco wine with a starting alcohol content of ±11% by volume;
47.00% white semi-sparkling wine with a starting alcohol content of ±11% by volume;
1.00% rectified concentrated grape must with a sugar content of ±67.8 Brix;
0.10% vanilla extract and natural flavoring in an alcoholic solvent of ethyl alcohol at 49% by volume;
10 g/l carbon dioxide deriving from natural fermentation.

### EXAMPLE 26

51.90% white sparkling Prosecco wine with a starting alcohol content of ±11% by volume;
44.60% white semi-sparkling wine with a starting alcohol content of ±11% by volume;
3.00% rectified concentrated grape must with a sugar content of ±67.8 Brix;
0.50% vanilla extract and natural flavoring in an alcoholic solvent of ethyl alcohol at 49% by volume;
10 g/l carbon dioxide deriving from natural fermentation.

### EXAMPLE 27

51.90% white sparkling Prosecco wine with a starting alcohol content of ±11% by volume;
44.10% white semi-sparkling wine with a starting alcohol content of ±11% by volume;
3.00% rectified concentrated grape must with a sugar content of ±67.8 Brix;
1.00% vanilla extract and natural flavoring in an alcoholic solvent of ethyl alcohol at 49% by volume;
10 g/l carbon dioxide deriving from natural fermentation.

### EXAMPLE 28

98.9% white sparkling Prosecco wine with a starting alcohol content of ±11% by volume;
1.00% rectified concentrated grape must with a sugar content of ±67.8 Brix;
0.1% vanilla extract and natural flavoring in an alcoholic solvent of ethyl alcohol at 49% by volume;
10 g/l carbon dioxide deriving from natural fermentation.

### EXAMPLE 29

96.5% white sparkling Prosecco wine with a starting alcohol content of ±11% by volume;
3.00% rectified concentrated grape must with a sugar content of ±67.8 Brix;
0.5% vanilla extract and natural flavoring in an alcoholic solvent of ethyl alcohol at 49% by volume;
10 g/l carbon dioxide deriving from natural fermentation.

### EXAMPLE 30

96.0% white sparkling Prosecco wine with a starting alcohol content of ±11% by volume;
3.00% rectified concentrated grape must with a sugar content of ±67.8 Brix;
1.00% vanilla extract and natural flavoring in an alcoholic solvent of ethyl alcohol at 49% by volume;
10 g/l carbon dioxide deriving from natural fermentation.

Any method amongst those commonly used for the preparation of aromatized wine-based drinks may be used to prepare the drinks disclosed.

The present invention brings important advantages.

The aromatized wine-based drinks disclosed preserve all the analytical and organoleptic characteristics of the variety of vine from which they derive, in the case in question Pinot grigio, Merlot, Shiraz and Prosecco or the generic wine without indication of the vine.

The addition of the flavoring preparation enhances, in a more or less marked fashion, the natural hint of vanilla present in varying degrees in the basic first wines used. Thus, the overall sensation perceived is one of a wine with a frank aroma (that is to say, precise, clean and clear), characteristic of the original variety of vine but delicately (lightly) vanilla-flavored.

Therefore, the result obtained is quite similar, at least for the average consumer, to that which could be achieved by aging the individual first wines used in oak casks.

The fact that aging is not necessary brings significant and obvious advantages in terms of production costs.

It should also be noticed that the present invention is relatively easy to implement and that even the cost linked to implementation of the invention is not very high.

The invention described may be subject to many modifications and variations without thereby departing from the scope of the inventive concept.

All details may be substituted with other technically equivalent elements, according to requirements.

1. An aromatized wine-based drink comprising:
a first wine selected either from Pinot grigio, Merlot, Shiraz, and Prosecco or a generic wine without indication of the vine, with a percentage by weight of between 51% and 99.4%;
rectified concentrated grape must with a percentage by weight of between 0.5% and 5%; and
a mixture of natural vanilla flavoring and vanilla extract with a percentage by weight of not less than 0.1%.

2. The aromatized wine-based drink according to claim 1, wherein the first wine has a starting alcohol content of between 10% and 12% by volume.

3. The aromatized wine-based drink according to claim 2, wherein the first wine has a starting alcohol content of approximately 11% by volume.

4. The aromatized wine-based drink according to claim 1, also comprising a second wine with a percentage by weight not higher than 48.4%.

5. The aromatized wine-based drink according to claim 4, wherein the second wine has a starting alcohol content of between 10% and 12% by volume.

6. The aromatized wine-based drink according to claim 5, wherein the second wine has a starting alcohol content of approximately 11% by volume.

7. The aromatized wine-based drink according to claim 1, wherein the rectified concentrated grape must has a sugar content of between 60 and 75 Brix.

8. The aromatized wine-based drink according to claim 7, wherein the rectified concentrated grape must has a sugar content of between 67 and 69 Brix.

9. The aromatized wine-based drink according to claim 4, wherein the rectified concentrated grape must has a sugar content of between 60 and 75 Brix.

10. The aromatized wine-based drink according to claim 9, wherein the rectified concentrated grape must has a sugar content of between 67 and 69 Brix.

11. The aromatized wine-based drink according to claim 1, wherein the mixture also comprises an alcoholic solvent of ethyl alcohol at 49% by volume.

12. The aromatized wine-based drink according to claim 4, wherein the mixture also comprises an alcoholic solvent of ethyl alcohol at 49% by volume.

13. The aromatized wine-based drink according to claim 4, wherein the first wine is white Pinot grigio or Prosecco wine, and the second wine is white wine.

14. The aromatized wine-based drink according to claim 4, wherein the first wine is red Merlot or Shiraz wine and the second wine is red wine.

15. The aromatized wine-based drink according to claim 1, wherein the first wine is semi-sparkling Prosecco wine.

16. The aromatized wine-based drink according to claim 4, wherein the first wine is semi-sparkling Prosecco wine.

17. The aromatized wine-based drink according to claim 1, wherein the first wine is sparkling Prosecco wine.

18. The aromatized wine-based drink according to claim 4, wherein the first wine is sparkling Prosecco wine

19. The aromatized wine-based drink according to claim 1, wherein the mixture comprises natural flavoring preparations including natural oak flavoring.

20. The aromatized wine-based drink according to claim 4, the mixture comprises natural flavoring preparations including natural oak flavoring.
